(19) United States
(12) Patent Application Publication
(10) Pub. No.: US 2026/0059357 A1
(43) Pub. Date: Feb. 26, 2026

(54) REPORTING OF APPLICATION LAYER MEASUREMENTS IN RRC-INACTIVE/IDLE MODES

(71) Applicant: Apple Inc., Cupertino, CA (US)

(72) Inventors: Ping-Heng Kuo, London (GB); Peng Cheng, Beijing (CN); Naveen Kumar R Palle Venkata, San Diego, CA (US); Fangli Xu, Beijing (CN); Ralf Rossbach, Munich (DE); Yuqin Chen, Beijing (CN); Pavan Nuggehalli, San Carlos, CA (US); Haijing Hu, Los Gatos, CA (US); Alexander Sirotkin, Hod Hasharon (IS); Sethuraman Gurumoorthy, San Ramon, CA (US); Zhibin Wu, Los Altos, CA (US)

(21) Appl. No.: 19/101,466

(22) PCT Filed: Jul. 12, 2023
(86) PCT No.: PCT/US2023/027444

§ 371 Date: Feb. 5, 2025

Related U.S. Application Data
(60) Provisional application No. 63/396,281, filed on Aug. 9, 2022.
(60) Provisional application No. 63/396,271, filed on Aug. 9, 2022.

(51) Int. Cl. H04W 24/08; H04L 41/5067; H04W 76/27

(52) U.S. Cl. CPC H04W 24/08; H04L 41/5067; H04W 76/27

(57) ABSTRACT

Techniques, described herein, include solutions for managing a buffer in a radio resource control (RRC) idle or RRC inactive state. A user equipment (UE) may be pre-configured by a base station to manage the buffer via RRC signaling while in the RRC connected state. The pre-configuration may additionally configure the UE to perform quality of experience (QoE) measurements in the RRC idle/inactive state. The UE may transition to RRC idle or RRC inactive, perform the QoE measurements, and store results of the QoE measurements in the buffer. During operation, the buffer may become full. Based on the pre-configuration, the UE may be configured to manage the buffer by removing outdated or less prioritized data when necessary.

### REFERENCE TO RELATED APPLICATIONS

This Application claims the benefit of U.S. Provisional Application No. 63/396,281, filed on Aug. 9, 2022, as well as U.S. Provisional Application No. 63/396,271, filed on Aug. 9, 2022, the contents of which are hereby incorporated by reference in their entirety

### FIELD

This disclosure relates to wireless communication networks including techniques for reporting QoE measurements.

### BACKGROUND

Wireless communication networks may include user equipments (UEs), base stations, and/or other types of wireless devices capable of communicating with one another. During operation, a UE may execute various applications, such as augmented reality (AR)/virtual reality (VR), multicast/broadcast services and audio/video streaming. A network may assess a users'quality of experience (QoE) for a certain application by obtaining application layer measurements (also referred to as QoE measurements) from the UE. The QoE measurements may provide useful information to optimize network resource allocation, or for purposes such as analytics.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) and a base station for QoE reporting and buffer management in inactive/idle mode in accordance with some aspects of the present disclosure.

FIG. 2 is a schematic diagram illustrating signaling between a UE and a base station for QoE reporting and buffer management in inactive/idle mode in accordance with some aspects of the present disclosure.

FIG. 3 is a flow diagram depicting a method for a UE to report QoE in inactive/idle mode in accordance with some aspects of the present disclosure.

FIG. 4 is a logic flow diagram for a UE configured to report QoE in inactive/idle mode in accordance with some aspects of the present disclosure.

FIGS. 5A-5C is a logic flow diagram for a UE configured to report QoE in accordance with some aspects of the present disclosure.

FIG. 6 is a flow diagram depicting a method for a base station to configure reporting of QoE in accordance with some aspects of the present disclosure.

FIGS. 7A-7D are a schematic diagram illustrating a buffer management process in accordance with some aspects of the present disclosure.

FIGS. 8A-8C are a schematic diagram illustrating a buffer management process in accordance with some aspects of the present disclosure.

FIG. 9 is a schematic diagram illustrating a process for performing QoE reporting in accordance with some aspects of the present disclosure.

FIG. 10 is a block diagram illustrating a device that can be employed in accordance with some aspects of the present disclosure.

FIG. 11 is a block diagram illustrating baseband circuitry that can be employed in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A user may experience various services through applications, such as web browsing, video gaming, audio/video streaming, AR/VR, multicast/broadcast services, or the like, through a User Equipment (UE). Quality of Experience (QoE) is a metric used to measure end-to-end performance of such services at the application level from perspective of the user. During operation, the UE may run various applications and perform corresponding QoE measurements. The QoE measurements, which may also be referred to as application layer measurements, may convey data relating to the user's experience of an application. For example, for video streaming, a corresponding QoE measurement relating to playout delay may indicate how long a frame has been stalled, or how long the video has been buffering. The UE may send a QoE report including QoE measurement results to a network.

QoE measurements and reporting may fall into two categories. “Regular” QoE measurements (which may also be referred to as “container based” QoE measurements), and “radio access network (RAN) visible” QoE measurements. Container based QoE measurements are included in a container that may be transmitted to the base station, and then forwarded by the base station to a management entity. The content of the container may not be visible to the base station. Container based QoE measurements may be used by Operations, Administration, and Maintenance (OAM) for purposes such as analytics. RAN visible QoE measurements, on the other hand, are reported to the base station and include contents visible to the base station. RAN visible QoE measurements may be utilized by the base station to improve radio resource management (RRM).

Currently, QoE reporting is only supported when the UE is in a radio resource control (RRC) connected state. When the UE is in an RRC inactive or RRC idle state, by implementation the application layer may continue to collect QoE measurements, but the Access Stratum (AS) can only report these measurements after the UE has returned to the RRC connected state. The measurements collected while in RRC idle/inactive may be stored in a buffer until the UE returns to the RRC connected state, where the buffered measurements are reported to the network.

However, storing measurement results in a buffer and only reporting while in the RRC connected state introduces several problems. In one scenario, the UE may stay in RRC idle/inactive for a long period of time without entering RRC connected and thus cannot perform QoE reporting for an extended period of time. Then there may be a large delay between when the QoE measurement is performed and when the QoE report is sent. The buffered measurement results may become outdated such that they are no longer useful and would be a waste of network resources to transmit. Further, when not performing QoE reporting for an extended period of time, the buffered QoE measurements may exceed the maximum memory that the UE supports (e.g. a size of the buffer). The UE may discard the oldest measurements in the buffer, or stop collecting measurements entirely.

Accordingly, the present disclosure relates to techniques to report QoE and manage a buffer while in the RRC idle or RRC inactive state according to some aspects. Before entering the RRC idle or RRC inactive state, a UE may be pre-configured while in the RRC connected state, to measure and report QoE while in the RRC idle/inactive state. The pre-configuration may be indicated to the UE from a base station (BS). As used herein, the term “base station” may be used to refer to a Next Generation Node B (gNB), Evolved Node B (eNB), or the like. The pre-configuration may be transmitted by RRC signaling or broadcast signaling, for example, in an RRC release message, an RRC reconfiguration message, or in a system information block (SIB). In some aspects, the pre-configuration may specify one or more priority levels, and discard measurement results from the buffer based on the priority levels when necessary. The pre-configuration may further include information such as QoE measurement configuration IDs and/or service types of applications. The pre-configuration may be dedicated to one or more specific QoE measurement configuration IDs and/or service types. For example, the pre-configuration may include an indication of which QoE measurement configuration IDs can trigger some aspects of QoE reporting, or which QoE measurement configuration IDs are associated with a certain priority level, etc. In some further additional aspects, the pre-configuration may include one or more expiry timers specifying one or more durations to store QoE measurements in the buffer before discarding. The one or more expiry timers may be used to determine when data is outdated and can be discarded.

In some further aspects, the QoE reporting may be triggered by a paging message from the BS while the UE is in RRC idle/inactive state. In response to the paging message, the UE may take several actions, including transmitting a measurement report using the small data transmission (SDT) mechanism defined in 3GPP specifications, returning to RRC connected to transmit the measurement report, or ignoring the paging message completely (e.g. if UE determines there are a small amount or no measurements to report). By ignoring the paging message, the UE may avoid performing signaling if there are little or no measurements to report. If the UE determines that it needs to report a small amount of measurements, it may report the measurements using SDT. By adaptively determining the method of transmission (SDT or transmitting in RRC connected), the UE may avoid unnecessary RRC signaling, for example, if there are a small amount of measurements to be reported.

In some further aspects, the UE may store the QoE measurements in a buffer and manage the buffer based on configuration by the BS. The UE may discard measurements under certain restrictions or conditions. In some aspects the UE may discard the measurements if they are determined to be expired, or may choose to discard certain measurements (e.g. based on a priority of the measurements) when the buffer is full. By being configured by the BS, the UE may identify and clear outdated measurements from the buffer before the buffer reaches full capacity. Further, when the buffer capacity is exceeded, the UE may discard the lowest priority measurements. The UE may avoid discarding high priority measurements, and include the high priority measurements in the next QoE report.

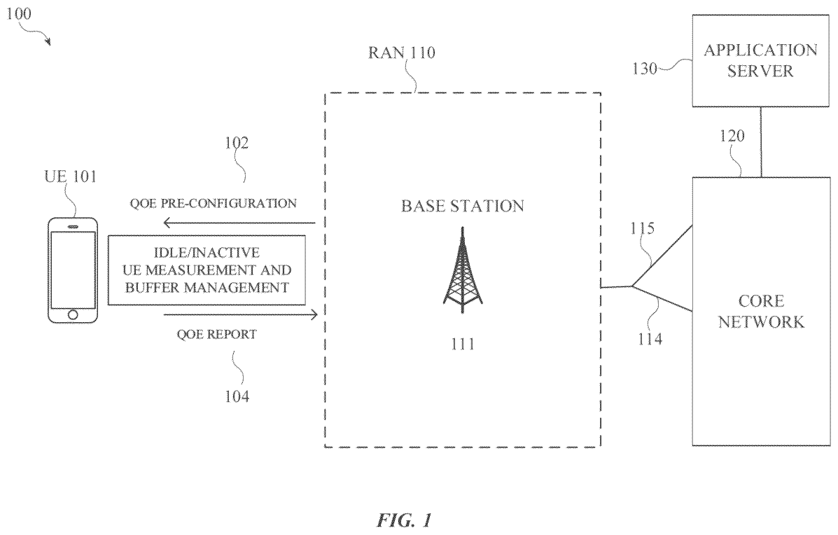

FIG. 1 illustrates an example architecture of a network system 100 in accordance with various aspects. The network system 100 includes a UE 101. In this example, the UE 101 is illustrated as a smartphone (e.g., a handheld touchscreen mobile computing device connectable to one or more cellular networks), but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The UE 101 can be configured to connect, for example, communicatively couple, with a RAN 110. The RAN 110 may comprise one or more base stations 111. In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN”or the like can refer to a RAN 110 that operates in an LTE or 4G system.

The UE 101 may perform QoE measurements in the RRC idle or RRC inactive state, and store QoE measurement results in a buffer. The UE 101 may utilize connections (or channels) 102 and 104 comprising a physical communications interface/layer for downlink and uplink respectively. The base station 111 may utilize downlink connection 102 to transmit network configurations, including a QoE pre-configuration to configure the UE 101 to perform the QoE measurements/reporting and manage the buffer while in RRC idle/inactive. The buffer may be used to store one or more QoE measurement results, and the contents of the buffer may be included in a QoE report to the base station. The pre-configuration may be included in an RRC message such as in an RRC release message or an RRC reconfiguration message transmitted in RRC connected state. The QoE pre-configuration may include information such as QoE measurement configuration identities (IDs), slice IDs, and/or service types. A QoE measurement configuration ID may specify a QoE measurement configuration, which may include parameters such as measurement period, duration, triggering conditions, etc. A slice ID may indicate a targeted network slice of the QoE measurement configuration. A service type may be a service type of an application, for example, AR/VR, video streaming, multicast/broadcast services, etc.

In some further aspects, the pre-configuration may configure the UE to manage the buffer while in the RRC idle/inactive state. The pre-configuration may specify when and/or how to discard measurement results from the buffer, for example, by configuring one or more expiry timers and/or priority levels. When a measurement result is stored in the buffer, an expiry timer may be started. Upon expiration of the expiry timer, the UE 101 may discard one or more associated measurement results from the buffer. The one or more associated measurement results may be associated with the expired expiry timer by QoE measurement configuration ID, slice ID, or service type. In some alternative aspects, the discarding can be performed based on the one or more priority levels of the stored measurements. The priority levels could be associated with the discarded measurements by QoE measurement configuration ID, slice ID, or service type. Discarding on priority level, for example, could be triggered when the buffer becomes full. An application server 130 may provide support for applications associated with the QoE measurements performed by the UE 101.

The QoE measurement results may be stored in the buffer. The UE 101 may send a QoE report to the base station 111 in response to a paging message, utilizing uplink connection 104. The method of sending the QoE report may be based the contents of the buffer. In some aspects, based on the contents of the buffer, the UE 101 may choose to ignore the paging message, transmit the report without entering RRC connected (e.g. using SDT), or entering RRC connected to transmit the report.

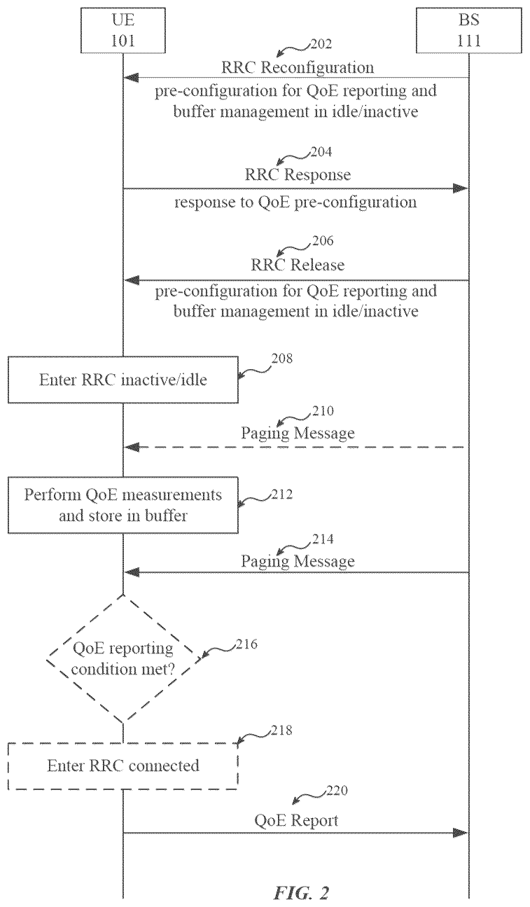

FIG. 2 is a schematic diagram illustrating signaling between a UE 101 and a base station 111 for performing QoE reporting and buffer management in accordance with some aspects. In some aspects, the base station 111 may send an RRC reconfiguration message 202 to the UE 101. The RRC reconfiguration message 202 may include a QoE pre-configuration used to configure the UE to perform QoE measurements and reporting while in the RRC idle or RRC inactive state. The QE measurements performed while in RRC idle/inactive may include regular QE and/or RAN-visible QoE measurements. The QoE pre-configuration could also include QoE measurement configuration IDs, slice IDs, and/or service types of applications, which may be utilized as described further in this disclosure.

In some aspects, the UE 101 responds with RRC response 204. The RRC response 204 may include an indication of a UE intention or preference to measure and/or report QoE measurements in the RRC idle/inactive state. The UE intention or preference may be based on UE conditions such energy level, priority, etc. For example, if the UE 101 is in a low energy state, the UE 101 could indicate that it does not intend to measure and/or report in RRC idle/inactive. Otherwise, the UE 101 could indicate that it intends to measure and/or report in RRC idle/inactive.

In some aspects, the base station 111 may send RRC release 206 to the UE 101, causing the UE 101 to terminate or suspend an RRC connected state with the base station 111.

At act 208, after exiting the RRC connected state, the UE 101 may enter RRC inactive or RRC idle mode. In some aspects, the RRC release 206 may include an additional QoE pre-configuration, which may be used to further configure/reconfigure the UE 101 in addition to the configuration performed based on the pre-configuration received in RRC reconfiguration 202. The additional QoE pre-configuration could also include QoE measurement configuration IDs, slice IDs, and/or service types of the applications. In another aspect, the QoE pre-configuration is transmitted only in the RRC release 206. Further, the QoE pre-configuration could also instruct the UE 101 to start performing QoE measurements upon entering RRC idle/inactive. Similar instruction could be provided by the QoE pre-configuration provided in RRC reconfiguration 202.

In some aspects, the base station 111 may optionally send a paging message 210 to the UE 101. The paging message 210 may cause the UE 101 to initiate or resume QoE reporting. The paging message 210 may be sent, for example, if the UE 101 was not instructed to directly proceed with QoE measurements upon entering RRC idle/inactive (e.g. via QoE pre-configuration in RRC release 206). The paging message 210 may comprise a paging cause indicating that the paging is to initiate or resume QoE measurement activities while in RRC idle or RRC inactive mode. Additionally, the paging message 210 may indicate one or more QoE measurement IDs, slice IDs, or service types it is referring to. For example, the paging message may indicate one or more QoE measurement configuration IDs, and the UE 101 may resume QoE measurement activities associated with the one or more QoE measurement configuration IDs. QoE measurement activities may include fetching/storing measurements from the application layer and/or generating QoE reports.

In some aspects, at act 212, the UE 101 may perform QoE measurements while in the RRC idle/inactive state. The UE 101 may be configured to continue performing QoE measurements until a paging message 214 is received. The UE 101 may perform a QoE measurement in a given measurement occasion. After each measurement occasion, the UE 101 may store one or more measurement results in a buffer. If a maximum size of the buffer is exceeded, the UE 101 may need to discard old measurements stored in the buffer to make room for new measurements to be stored. In response to the stored QoE measurements exceeding the size of the buffer, the UE 101 may discard some or all of the measurements. The discarding could be based on UE implementation, or based on pre-configured priority levels of measurements in the buffer. The priority levels could be configured via the pre-configuration, and the priority levels could be assigned on a per QoE measurement configuration ID, per slice ID, or per service type basis. More detailed examples of techniques to manage the buffer are described further in this disclosure.

In some aspects, the UE 101 may receive a paging message 214. The paging message 214 may cause the UE 101 to report QoE measurements (e.g. send QoE report 220) to the base station 111. The paging message 214 may include a paging cause indicating that the paging message 214 is a request for a QoE report. The paging message 214 may further include one or more QoE measurement configuration IDs, slice IDs, or service types to identify one or more requested QoE measurements.

In some aspects, the paging message 214 and/or paging message 210 may be preceded by an early paging indication (EPI). The early paging indication may be sent by the base station 111 to a plurality of UEs, which may include UE 101, via downlink control information (DCI). A UE of the plurality of the UEs may avoid unnecessary physical downlink shared channel (PDSCH) decoding of a paging message (e.g. paging message 214 and/or paging message 210) if the EPI indicates that the paging message is not for the UE. Since the EPI is sent to a plurality (e.g. a sub-group) of UEs, the EPI could be extended to trigger QoE reporting or QoE measurement activities for multiple UEs simultaneously. Since QoE reporting in idle/inactive mode is mainly for multicast/broadcast services (MBS), this could be particularly useful. Upon reception of a triggering indication for QoE reporting and/or QoE measurement activities in the EPI, the UE could trigger the corresponding reporting and/or measurement activities directly, without having to decode the paging message.

In some aspects, the UE 101 may optionally check if a reporting condition is met at act 216. The condition check may, for example, include checking a size of measurements in the buffer. In some aspects, the size may include a size in bits/bytes. In some aspects, the size of the measurements may include a number of measurements in the buffer. In some aspects, the condition check may include comparing the size of the measurements in the buffer to a first threshold value. If the size of the measurements is less than the first threshold value, the UE 101 may ignore the paging message 214. In some aspects, the condition check may include comparing the size of the measurements in the buffer to a second threshold value. If the size of the measurements is greater than the second threshold value, the UE 101 may choose to enter RRC connected at act 218 to send QoE report 220. If the size of the measurements is less than the second threshold value, the UE 101 may choose to send the QoE report 220 without entering RRC connected. The first and second threshold values may pre-determined values, or may be configured via the QoE pre-configuration.

The decision to enter RRC connected may be based on the size of the measurements in the buffer relative to the second threshold value. In some aspects, the size of the measurements in the buffer may be a size of a sub-set of measurements in the buffer. The sub-set of measurements may include the measurements to be reported, which may correspond to the QoE measurement configuration IDs, slice IDs, or service types specified in the paging message 214.

In some aspects, the UE 101 may enter RRC connected at act 218. The decision to enter RRC connected may be based on the result of the condition check at act 216. In some aspects, the UE 101 may send a QoE report 220 while in the RRC connected state to the base station 111. The QoE report may include one or more measurement results from the buffer, which may be associated with a QoE measurement configuration ID, slice ID, or service type specified in the paging message 214. The QoE report 220 may be transmitted via a physical layer transmission such as on a physical uplink shared channel (PUSCH). If the UE 101 is unable to send the QoE report 220 (e.g. due to low battery or privacy issues), the UE 101 may notify the base station 111 that it is unable to report QoE.

In some aspects, the UE 101 may skip act 218, and not enter RRC connected. The decision to not enter RRC connected may be based on the result of the condition check at act 216. The UE 101 stays in RRC idle or RRC inactive, and the QoE report 220 may be transmitted using SDT. The base station 111 may pre-configure (e.g. via pre-configuration) signaling radio bearer (SRB) 4 as a SDT radio bearer. Alternatively, the base station 111 may pre-configure (e.g. via pre-configuration) a list of QoE measurement configuration IDs that can trigger SDT procedures. If the UE 101 is unable to send the QoE report 220 (e.g. due to low battery or privacy issues), the UE 101 may notify the base station 111 that it is unable to report QoE.

In some alternative aspects, act 216 is skipped. The UE 101 enters RRC connected at act 218 and sends the QoE report 220 in the RRC connected state without performing the condition check at act 216. Upon entering RRC connected at act 218, the UE 101 may indicate to the base station 111 whether there are stored measurements in the buffer, and may also indicate the size of the measurements stored in the buffer.

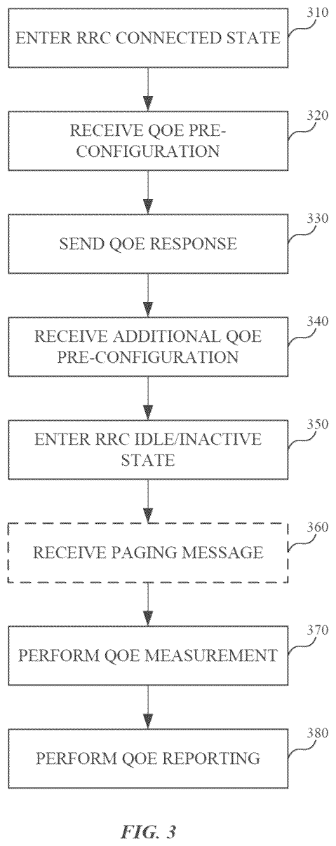

FIG. 3 is a flow diagram depicting a method for reporting QoE measurements in accordance with some aspects. In some aspects, the method is performed by a UE. In some aspects, the UE is UE 101. At act 310, the UE enters the RRC connected state. At act 320, the UE receives an RRC reconfiguration message from a base station. In some aspects, the base station is base station 111. In some aspects, the RRC reconfiguration message includes a QoE pre-configuration to configure QoE measurements in RRC idle/inactive. The pre-configuration may include information such as QoE measurement configuration IDs, slice IDs, and/or service types. The pre-configuration may further include one or more expiry timers. The expiry timers could be assigned per QoE measurement configuration ID, per slice ID, or per service type. The UE may start an expiry timer when an associated measurement is stored in a measurement buffer, and may clear the measurement from the buffer upon expiration of the expiry timer. The pre-configuration may also include one or more priority levels assigned on a per QoE measurement configuration ID, per slice ID, or per service type basis.

In some aspects, at act 330, the UE may send an RRC response message to the base station. The RRC response message may include an intention of the UE to measure and/or report QoE measurements while in RRC idle/inactive. The intention may be based on a character parameter of the UE (e.g. an energy level). For example, the UE may choose not to report in RRC idle/inactive if the UE has low battery.

In some aspects, at act 340, the UE may receive an RRC release message from the base station. The RRC release message may include an additional QoE pre-configuration which may be used to further configure/reconfigure the UE for QoE measurements in RRC idle/inactive. The additional pre-configuration may include similar information as the pre-configuration, such as QoE measurement configuration IDs, slice IDs, service types, expiry timers, and priority levels. In some aspects, the additional pre-configuration may instruct the UE to perform QoE measurements upon entering RRC idle/inactive. Otherwise, the UE may not perform QoE measurements upon entering RRC idle/inactive.

In some aspects, the UE does not receive an RRC reconfiguration message and/or the RRC reconfiguration message does not include a QoE pre-configuration. In this case, the additional pre-configuration (included in RRC release) is used to initially configure the UE to report QoE measurements. In some alternative aspects, the RRC reconfiguration message includes a QoE pre-configuration, and the RRC release does not include the additional QoE pre-configuration. In this case, no further configuration/reconfiguration is done via RRC release.

In some aspects, at act 350 the UE enters the RRC idle or RRC inactive state. In some aspects, at act 360, the UE may optionally receive a paging message. The paging message may include a paging cause indicating that the UE may initiate/resume QoE measurement and reporting. This may occur, for example, if the UE was not instructed to proceed with QoE measurements upon entering RRC idle/inactive. The paging message may indicate which QoE measurement IDs, slice IDs, or service types the paging message is referring to. Based on the QoE measurement IDs, slice IDs, or service types indicated in the paging message, the UE may resume QoE measurement activities.

In some aspects, at act 370, the UE may perform the configured QoE measurement. In some aspects, the UE may periodically continue to perform the configured QoE measurements until a paging message is received. At act 380, the UE may perform QoE reporting as detailed by FIGS. 4-6.

FIG. 4 illustrates a logic flow for a UE configured to report QoE measurements in accordance with some aspects. In some aspects, FIG. 4 represents some specific examples for act 380 of FIG. 3. In some aspects, at act 410, the UE receives a paging message from the base station. The paging message may include a paging cause indicating that the paging message is a request for a QoE report, and may further indicate which service type(s), slice ID(s), or QoE measurement configuration ID(s) the paging cause refers to, as previously described.

At act 420, in some optional aspects, the UE may determine if it is able to report. The determination may be made based on a character parameter of the UE (e.g. an energy level). If the UE determines that it cannot report (e.g. due to low energy level), the UE may send a notification message to the base station at act 480 to indicate that it is unable to report. Otherwise, the UE may proceed to act 430.

In some optional aspects, at act 430, the UE may check if the measurement buffer is empty. If the measurement buffer is empty, the UE may ignore the paging message at act 470.

Otherwise, the UE may enter the RRC connected state at act 440. In some alternative aspects, instead of checking if the buffer is empty, the UE may check if the size of the measurements in the buffer is less than a first threshold value. The size of the measurements may include a size of the measurements in bits or a number of measurements. The size of the measurements may be a size of all of the measurements, or a size of a sub-set of measurements, as previously described. If the size of the measurements in the buffer is less than the first threshold value, the UE will ignore the paging message at act 470. Otherwise the UE may enter the RRC connected state at act 440.

In some aspects, at act 440, the UE may enter the RRC connected state. In some aspects, upon entering the RRC connected state, the UE may optionally send measurement info at act 450. The measurement info may, for example, be included in RRC resume complete or similar signaling. The measurement info may include an indication that the UE has stored QoE measurements in the buffer. In some aspects, the measurement info further indicates how many measurements are stored in the buffer (e.g. the size of the measurements). Based on the size of the measurements, the network may choose a size of an uplink resource to allocate for a QoE report.

In some aspects, at act 460, the UE sends the QoE report to the base station while in the RRC connected state. The QoE report may include one or more measurement results from the buffer. The one or more measurement results may be associated with one or more QoE measurement configuration IDs, slice IDs, or service types specified in the paging message received at act 410.

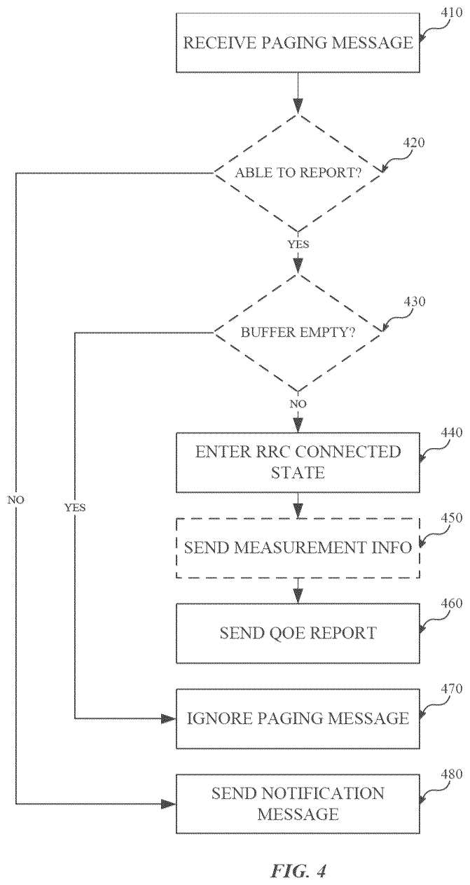

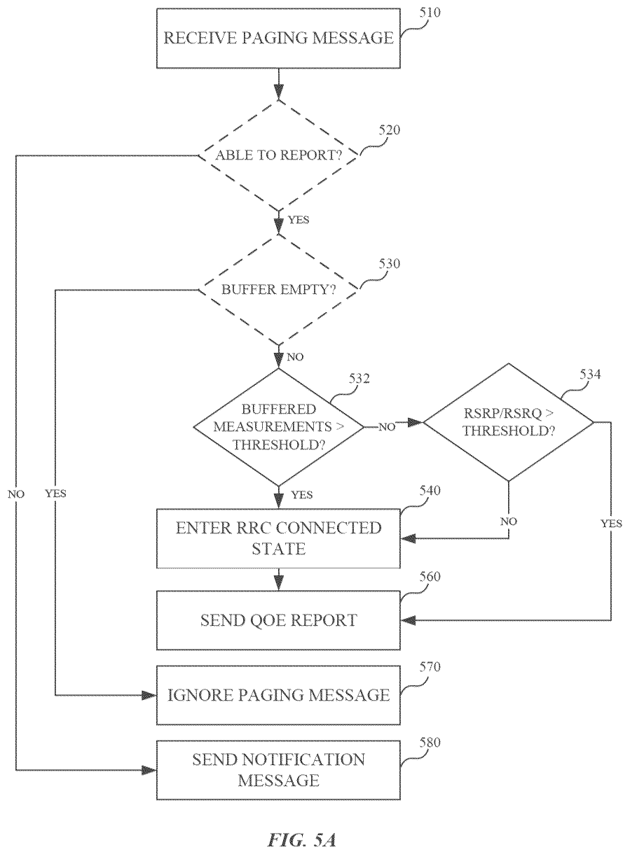

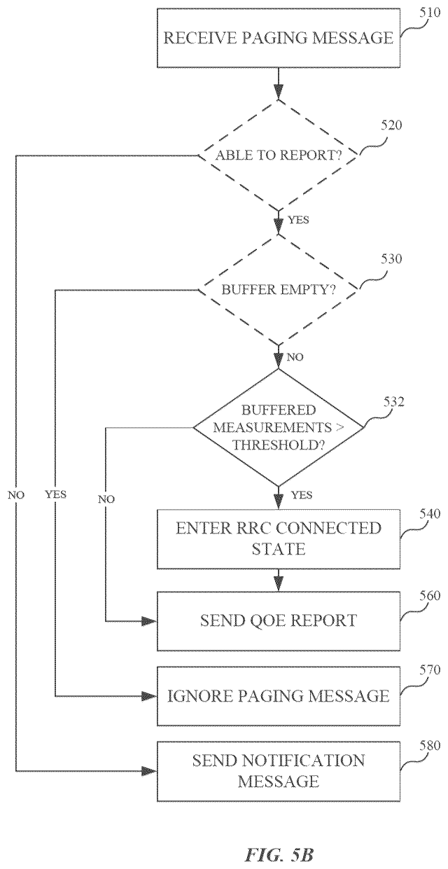

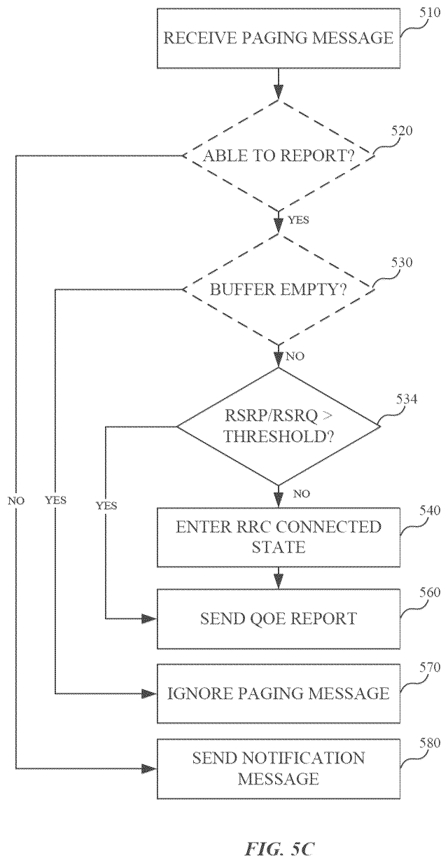

FIGS. 5A-5C illustrate logic flows for a UE configured to report QoE measurements in accordance with some aspects. In some aspects, FIG. 5A, FIG. 5B, or FIG. 5C may represent some specific examples for act 380 of FIG. 3.

FIG. 5A illustrates one possible example. In some aspects, at act 510, the UE receives a paging message from the base station. The paging message may include a paging cause indicating that the paging message is a request for a QoE report, and may further indicate which service type, slice IDs, or QoE measurement configuration ID the paging cause refers to, as previously described.

At act 520, in some optional aspects, the UE may determine if it is able to report. The determination may be made based on a character parameter of the UE (e.g. an energy level). If the UE determines that it cannot report (e.g. due to low energy level), the UE may send a notification message to the base station at act 580 to indicate that it is unable to report. Otherwise, the UE may proceed to act 530.

In some optional aspects, at act 530, the UE may check if the measurement buffer is empty. If the measurement buffer is empty, the UE may ignore the paging message at act 570. Otherwise, the UE may proceed to act 532. In some alternative aspects, instead of checking if the buffer is empty, the UE may check if the size of the measurements in the buffer is less than a first threshold value. The size of the measurements may include a size of the measurements in bits or a number of measurements. The size of the measurements may be a size of all of the measurements, or a size of a sub-set of measurements, as previously described. If the size of the measurements in the buffer is less than the first threshold value, the UE will ignore the paging message at act 570.

In some aspects, at act 532, the UE may check if the size of the measurements in the buffer is greater than a second threshold value. If the size of the measurements is greater than the second threshold value, the UE may enter the RRC connected state at act 540 and send a QoE report at act 560. In some aspects, the second threshold value may be greater than the first threshold value.

In some aspects, if the size of the measurements is not greater than the second threshold value, at act 534, the UE may check if a reference signal received quality (RSRQ) value is greater than a RSRQ threshold value. The RSRQ value may be obtained, for example, by the UE performing a synchronization signal/physical broadcast channel block (SSB) measurement to assess a channel quality of the cell. If the RSRQ value is greater than the RSRQ threshold value, the UE may proceed to act 560 and send the QoE report. Otherwise, the UE may enter the RRC connected state at act 540 before proceeding to act 560.

In some additional or alternative aspects, at act 534, the UE may check if a reference signal received power (RSRP) value is greater than a RSRP threshold value. The RSRP value may be obtained, for example, from an SSB measurement. If the RSRP value is greater than the RSRP threshold value, the UE may proceed to act 560 and send the QoE report. Otherwise, the UE may enter the RRC connected state at act 540 before proceeding to act 560.

In some aspects, at act 560, the UE sends a QoE report to the base station. The QoE report may contain one or more measurement results stored in the buffer. The one or more measurement results may be associated with one or more QoE measurement configuration IDs, one or more slice IDs, or one or more service types specified in the paging message received at act 510. The method for sending the QoE report may vary depending on if the UE is in RRC connected. If the UE is in the RRC connected state, then the QoE report may be sent using PUSCH. If the UE is not in the RRC connected state (e.g. in the RRC inactive state), then the QoE report may be sent using SDT. The base station may, using the pre-configuration, pre-configure SRB4 as a SDT radio bearer, or may pre-configure a list of QoE measurement configuration IDs that can trigger SDT procedures.

As shown in FIG. 5A-5C, act 532 and act 534 may be performed individually or in combination. Various conditions may trigger the UE to enter the RRC connected state for QoE reporting (e.g. size of buffered measurements>second threshold for FIG. 5B, RSRP/RSRQ<threshold for FIG. 5C, or either of the aforementioned conditions for FIG. 5A). By performing various condition checks to determine whether to enter the RRC connected mode to report, the UE may reduce the number of occasions where transition to RRC connected is required, thereby reducing the amount of RRC signaling and also reducing power consumption.

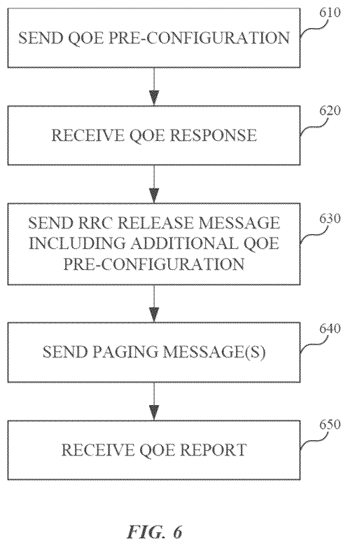

FIG. 6 is a flow diagram depicting a method for reporting QoE measurements in accordance with some aspects. In some aspects, the method is performed by a base station, which may be base station 111.

In some aspects, at act 610, the base station sends an RRC reconfiguration message to a UE, which may be UE 101. In some aspects, the RRC reconfiguration may include a QoE pre-configuration to configure QoE measurements in RRC idle/inactive. The pre-configuration may include one or more QoE measurement configuration IDs, one or more slice IDs, and/or one or more service types. The pre-configuration may further include one or more expiry timers, which may be associated with QoE measurement configuration IDs, slice IDs, and/or service types. An expiry timer may specify a duration for a measurement to be stored in a buffer before being discarded. Alternatively, the RRC reconfiguration message may not include the QoE pre-configuration, and the pre-configuration is provided in the RRC release message as detailed below.

At act 620, in some aspects, the base station receives an RRC response message from the UE. The RRC response message may include an intention of the UE to measure and/or report QoE measurements while in RRC idle/inactive. The intention may indicate, for example, that the UE intends to report, or that the UE does not intend to report.

At act 630, in some aspects, the base station sends an RRC release message to the UE. In some aspects, the RRC release message may include an additional QoE pre-configuration. The additional QoE pre-configuration may be used to configure (e.g. if the RRC reconfiguration did not include a pre-configuration) QoE measurements in RRC idle/inactive, or maybe used to reconfigure (e.g. if RRC reconfiguration provided a pre-configuration) QoE measurements in RRC idle/inactive. Using the RRC release message, the base station may or may not instruct the UE to perform QoE measurements upon entering RRC idle/inactive mode.

At act 640, in some aspects, the base station will send paging messages to the UE. If the base station did not previously instruct the UE to perform QoE measurements upon entering RRC idle/inactive, then the base station may send a first paging message to the UE. The first paging message may have a first paging cause indicating that the UE is to initiate/resume QoE measurements. The first paging message may include one or more QoE measurement IDs, one or more slice IDs, and/or one or more service types associated with the measurements the UE is to initiate/resume. The base station may then send a second paging message to the UE. The second paging message may have a paging cause indicating a request for a QoE report. The second paging message may additionally include one or more QoE measurement IDs, one or more slice IDs, and/or one or more service types associated with requested QoE measurement data. At act 650, in some aspects, the base station receives the QoE report from the UE. The QoE report may contain the QoE measurement data associated with the one or more QoE measurement configuration IDs, slice IDs, and/or service types included in the second paging message.

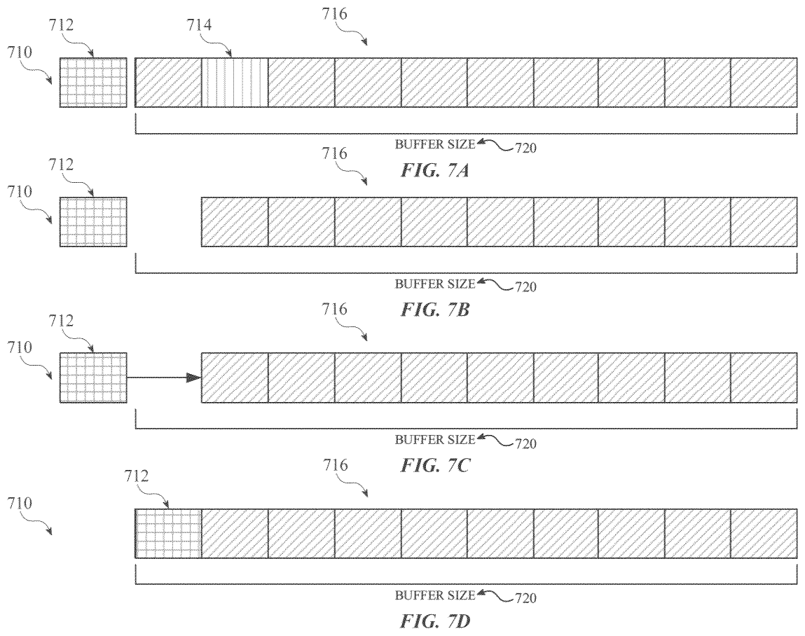

FIGS. 7A-7D are schematic diagrams illustrating a buffer management process in accordance with some aspects. As previously described, a UE (e.g. UE 101) may perform a QoE measurement while in RRC idle/inactive to obtain a QoE measurement result 712. The UE may store the QoE measurement result 712 in a buffer 710, and the UE may report some or all of the contents of the buffer 710 upon receiving a paging message from a base station (e.g. base station 111). The buffer 710 may have a buffer size 720, and may contain a plurality of measurement results 716. The plurality of measurement results 716 may include a measurement result 714. If a size of the measurement results 716 in the buffer 710 exceeds the buffer size 720, then one or more measurement results need to be removed from the buffer 710 before inserting the new measurement result 712. In some aspects, some of the measurement results are removed from the buffer 710. In some aspects, all of the measurement results are removed from the buffer 710.

In some aspects, FIG. 7A depicts a first step of the buffer management process. The measurement result 714 within the buffer 710 is chosen to be discarded to clear space in the buffer 710 for the new measurement result 712.

In some aspects, the choice to discard measurement result 714 is based on a pre-configured priority level. For example, measurement result 714 is discarded in response to measurement result 714 having a lowest priority of measurement results in the buffer. The priority level could be pre-configured via the pre-configuration or additional pre-configuration as previously described. The pre-configuration or additional pre-configuration may include one or more priority levels, and the one or more priority levels could be assigned on a per QoE measurement configuration ID, per slice ID, or per service type basis.

In some aspects, the choice to discard measurement result 714 is due to expiration of an expiry timer associated with the measurement result 714. In this case, the measurement result 714 is discarded when the associated expiry timer expires. In some aspects, this may occur before obtaining the new measurement result 712. The expiry timer may be the expiry timer as previously described, and may be communicated via pre-configuration and assigned on a per QoE measurement configuration ID, slice ID, or service type basis. In some alternative aspects, the choice to discard is based on an implementation of the UE.

In some aspects, FIG. 7B depicts a second step of the buffer management process. The measurement result 714 is discarded, and the buffer 710 now has room to store measurement result 712.

In some aspects, FIG. 7C depicts a third step of the buffer management process. The measurement result 712 is inserted into the buffer 710.

In some aspects, FIG. 7D depicts an end result of the buffer management process. The measurement result has been inserted into the buffer 710 and the measurement result 714 has been discarded. Although FIGS. 7A-7D illustrate a single measurement result 714 being discarded from the buffer 710, a similar process could be repeated for multiple measurements. For example, measurement result 712 and/or measurement result 714 may each represent a plurality of measurements. Discarding multiple measurements may be necessary depending on how much buffer space is needed.

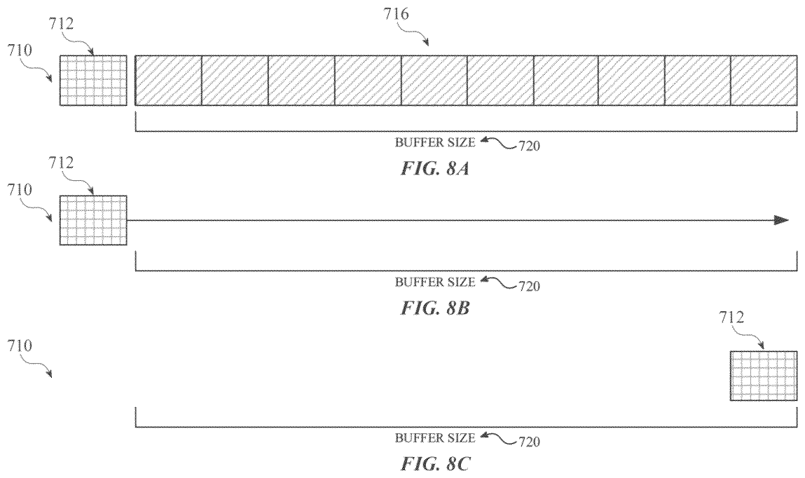

FIGS. 8A-8C are schematic diagrams illustrating a buffer management process in accordance with some aspects. In some aspects, an entirety of measurement results 716 are cleared from a buffer 710.

In some aspects, FIG. 8A depicts a first step of the buffer management process. The measurement results 716 are all chosen to be discarded from the buffer. The choice may, for example, be made based on an implementation of the UE.

In some aspects, FIG. 8B depicts a second step of the buffer management process. The new measurement result 712 is added into the empty buffer.

In some aspects, FIG. 8C depicts an end result of the buffer management process. The new measurement result 712 is now the only measurement result stored in the buffer.

In aspects, the CN 120 can be a 5GC (referred to as “5GC 120” or the like), and the RAN 110 can be connected with the CN 120 via two parts, a Next Generation (NG) user plane (NG-U) interface 114, which carries traffic data between the RAN nodes and a User Plane Function (UPF), and the S1 control plane (NG-C) interface 115, which is a signaling interface between the RAN nodes and Access and Mobility Management Functions (AMFs).

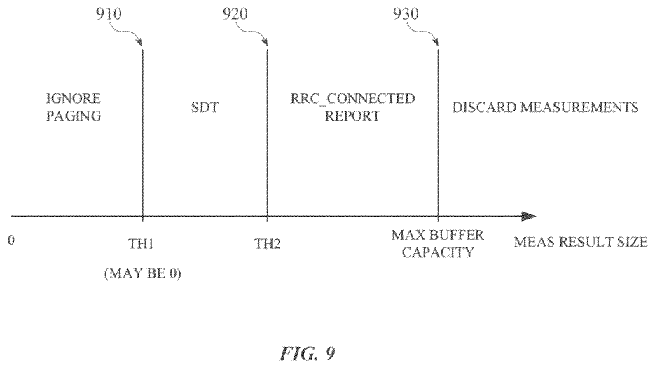

FIG. 9 is a schematic diagram illustrating a process for performing QoE reporting in accordance with some aspects. As previously described, a UE (e.g. UE 101) may compare the size of contents of a buffer to various threshold values to determine how to report QoE. In some aspects, the contents may be the contents to be reported, which may be the entire contents of the buffer, or may be a sub-set of contents specified by QoE measurement configuration IDs, slice IDs, or service types. The QoE measurement configuration IDs, slice IDs, or service types may be included in a paging message, and the paging message may have a paging cause indicating that the paging message is a request for a QoE report.

In some aspects, the UE compares the size of the contents to a first threshold value 910. The first threshold value 910 may be a first threshold value. If the size of the contents is less than the first threshold value 910, then the UE may ignore the paging message, and not perform QoE reporting. In some aspects, the first threshold value 910 is 0. In alternative aspects, the first threshold value 910 is greater than 0.

In some aspects, if the size of the contents is greater than the first threshold value 910, the UE further compares the size of the contents to a second threshold value 920. If the size of the contents is less than the second threshold value 920, then the UE may report QoE using SDT, as previously described. If the size of the contents is greater than the second value 920, then the UE may enter RRC connected to report QoE.

While in RRC idle/inactive, the UE may perform QoE measurements and store QoE measurement results in the buffer. When storing a measurement, the UE may check if the buffer is full. If a maximum buffer capacity 930 (i.e. size of the buffer) is exceeded, then the UE will discard one or more measurements to make room for the new measurement. In some aspects, the discarding is based on a priority of the measurements in the buffer. The priority of the measurements may be based on the QoE pre-configuration, as previously described. In some aspects, discarding may be based on an expiry timer, and the discarding may occur before the buffer is actually full (e.g. when the timer expires). The timer expiring may indicate that the measurement data is no longer useful, and can be discarded.

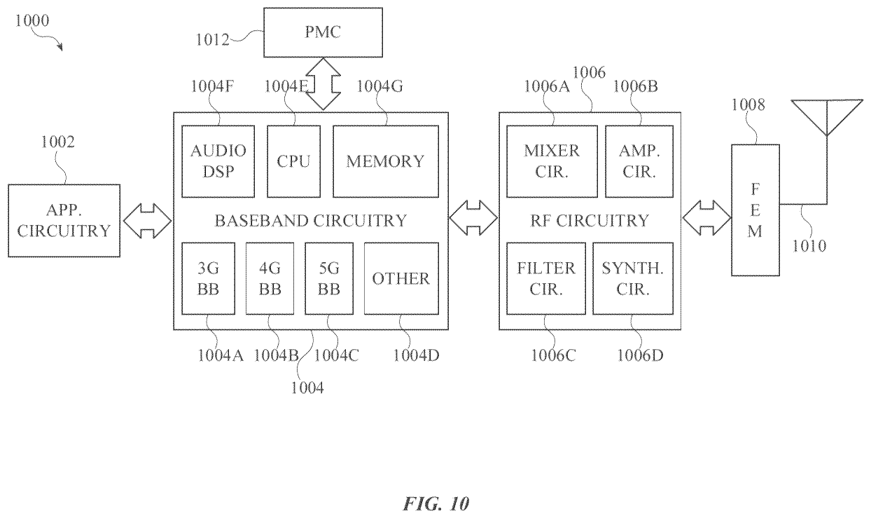

FIG. 10 is a diagram illustrating example components of a device 1000 that can be employed in accordance with some aspects of the present disclosure. In some aspects, the device 1000 can include application circuitry 1002, baseband circuitry 1004, Radio Frequency (RF) circuitry 1006, front-end module (FEM) circuitry 1008, one or more antennas 1010, and power management circuitry (PMC) 1012 coupled together at least as shown. The components of the illustrated device 1000 can be included in a UE or a RAN node such as the UE 101 or the BS 111 as described, for example, with reference to FIGS. 1-2 and throughout the present disclosure. In some implementations, the device 1000 can include fewer elements (e.g., a RAN node may not utilize application circuitry 1002 and instead include a processor/controller to process IP data received from a CN, which may be a 5GC or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuitry 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 2G, 6G, etc.).

The baseband circuitry 1004 (e.g., one or more of baseband processors 1004A-D) can handle various radio control functions that enable communication with one or more radio networks via the RF circuitry 1006. In other implementations, some or all of the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some implementations, the baseband circuitry 1004 can include one or more audio digital signal processor(s) (DSP) 1004F.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path.

The baseband circuitry 1004, or the one or more baseband processors or control logic of the baseband circuitry 1004, may stand alone as the UE 101 or the base station 111 perform signaling and operation in the meaning as described throughout this disclosure.

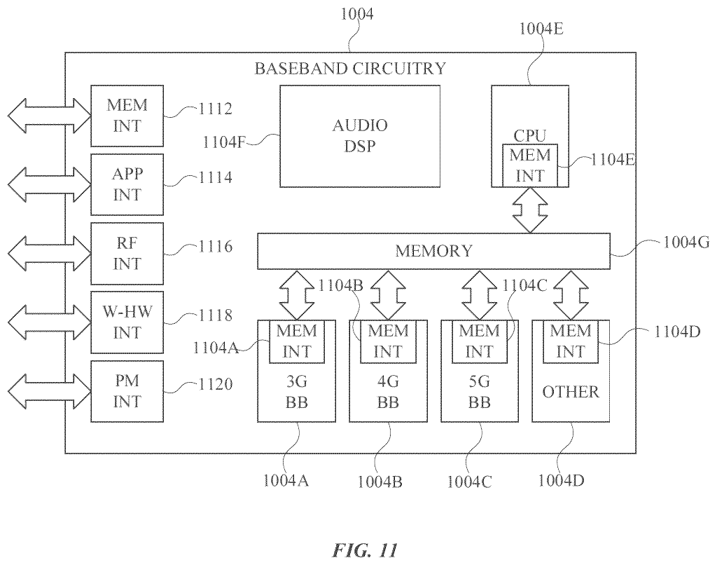

FIG. 11 illustrates a diagram illustrating example interfaces of baseband circuitry that can be employed in accordance with some aspects. As discussed above, the baseband circuitry 1004 of FIG. 10 can comprise processors 1004A-1004E and a memory 1004G utilized by said processors. Each of the processors 1004A-1004E can include a memory interface, 1104A-1104E, respectively, to send/receive data to/from the memory 1004G.

The baseband circuitry 1004 can further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1120 (e.g., an interface to send/receive power or control signals to/from the PMC 1012).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus for a User Equipment (UE) comprising one or more processors configured to: in a radio resource control (RRC) connected state, receive an RRC message including a quality of experience (QoE) pre-configuration to configure QoE reporting in an RRC idle or inactive state, terminate or suspend the RRC connected state with a base station and enter the RRC idle or inactive state, and in the RRC idle or inactive state, perform the QoE reporting based on the QoE pre-configuration.

Example 2 comprises the subject matter of any variation of example 1, wherein the RRC message is an RRC reconfiguration message, and wherein the one or more processors are further configured to receive an RRC release message after receiving the RRC reconfiguration message, wherein the RRC release message includes an additional QoE pre-configuration, and wherein the QoE reporting is further based on the additional QoE pre-configuration.

Example 3 comprises the subject matter of any variation of example 1, wherein the RRC message is an RRC release message.

Example 4 comprises the subject matter of any variation of example 3, wherein the one or more processors perform a QoE measurement upon terminating or suspending the RRC connected state with the base station as configured by the RRC release message.

Example 5 comprises the subject matter of any variation of example 1, wherein the one or more processors are further configured to: perform a QoE measurement in the RRC idle or inactive state based on the QoE pre-configuration, and store a result of the QoE measurement in a buffer, wherein performing the QoE reporting comprises sending a QoE report message to the base station, and wherein the QoE report message includes the result of the QoE measurement stored in the buffer.

Example 6 comprises the subject matter of any variation of example 5, wherein the one or more processors are further configured to: receive a paging message before sending the QoE report message, wherein the paging message includes a paging cause indicating that the paging message is a request for a QoE report.

Example 7 comprises the subject matter of any variation of example 6, wherein the one or more processors are further configured to: in response to the paging message, enter the RRC connected state, wherein the QoE report message is sent to the base station while in the RRC connected state.

Example 8 comprises the subject matter of any variation of example 7, wherein the one or more processors are further configured to: before entering the RRC connected state, determine that a size of results of QoE measurements in the buffer exceeds a second threshold value.

Example 9 comprises the subject matter of any variation of example 6, wherein the QoE report message is part of a small data transmission (SDT) message.

Example 10 comprises the subject matter of any variation of example 9, wherein the QoE report message is sent in response to a size of QoE measurements in the buffer being lower than a second threshold value.

Example 11 comprises the subject matter of any variation of example 9, wherein the QoE report message is sent in response to a reference signal received power (RSRP) value being higher than a threshold value.

Example 12 comprises the subject matter of any variation of example 9, wherein the QoE report message is sent in response to a reference signal received quality (RSRQ) value being higher than a threshold value.

Example 13 comprises the subject matter of any variation of example 9, wherein the SDT message is sent via signaling radio bearer (SRB) 4.

Example 14 comprises the subject matter of any variation of example 6, wherein the paging message includes a QoE measurement configuration identity (ID) associated with the performed QoE measurement, a service type associated with the performed QoE measurement, or a slice ID associated with the performed QoE measurement.

Example 15 comprises the subject matter of any variation of example 7, wherein the one or more processors are further configured to: upon entering the RRC connected state, send an RRC resume complete message to the base station indicating a size of QoE measurements stored in the buffer.

Example 16 comprises the subject matter of any variation of example 6, wherein the one or more processors are further configured to: receive a second paging message before the paging message, the second paging message including the paging cause indicating that the paging message is a request for a QoE report, and ignore the second paging message in response to a size of results of QoE measurements in the buffer being lower than a first threshold value.

Example 17 comprises the subject matter of any variation of example 1, wherein the one or more processors are further configured to: upon receiving the QoE pre-configuration, determine whether to measure or report QoE in the RRC idle or inactive state, and transmit the determination of whether to measure or report QoE in the RRC idle or inactive state to the base station.

Example 18 comprises the subject matter of any variation of example 17, wherein the determination to measure or report QoE is based on a character parameter of the UE.

Example 19 is an apparatus for a base station comprising one or more processors configured to: send a radio resource control (RRC) reconfiguration message including a quality of experience (QoE) pre-configuration to a UE, wherein the QoE pre-configuration configures the UE for QoE reporting in an RRC idle or inactive state, send an RRC release message to terminate or suspend an RRC connected state with the UE, and receive a QoE report message from the UE, wherein the QoE report message includes a result of a QoE measurement performed by the UE while in the RRC idle or RRC inactive state, and wherein the QoE report message is based on the QoE pre-configuration.

Example 20 comprises the subject matter of any variation of example 19, wherein the RRC release message includes an additional QoE pre-configuration to further configure/reconfigure QoE reporting in the RRC idle or inactive state.

Example 21 comprises the subject matter of any variation of example 19, wherein the one or more processors are further configured to: send a paging message to the UE including an indication to resume QoE measurement activities, wherein the QoE report message is received in response to the indication.

Example 22 comprises the subject matter of any variation of example 21, wherein the paging message includes a QoE measurement configuration identity (ID) associated with the QoE measurement.

Example 23 comprises the subject matter of any variation of example 21, wherein the paging messages includes a service type associated with the QoE measurement.

Example 24 comprises the subject matter of any variation of example 21, wherein the one or more processors are further configured to: send a downlink control information (DCI) message to a plurality of UEs before sending the paging message, the DCI comprising an early paging indication (EPI), wherein the QoE report message is received in response to the DCI message.

Example 25 is a method to be performed by a User Equipment (UE), comprising: in an RRC connected state, receiving a radio resource control (RRC) message including a quality of experience (QoE) pre-configuration to configure QoE reporting in an RRC idle or inactive state; terminating or suspending the RRC connected state with a base station and entering the RRC idle or inactive state; and in the RRC idle or inactive state, performing the QoE reporting based on the QoE pre-configuration.

Example 26 comprises the subject matter of any variation of example 25, the method further comprising: receiving an RRC release message after receiving the RRC message, wherein the RRC message is an RRC reconfiguration message, wherein the RRC release message includes an additional QoE pre-configuration, wherein the QoE reporting is further based on the additional QoE pre-configuration, and wherein the RRC message is an RRC reconfiguration message.

Example 27 comprises the subject matter of any variation of example 25, wherein the RRC message is an RRC release message.

Example 28 comprises the subject matter of any variation of example 25, the method further comprising: performing a QoE measurement in the RRC idle or inactive state, and storing a result of the QoE measurement in a buffer, wherein performing the QoE reporting comprises sending a QoE report message to the base station, and wherein the QoE report message includes the result of the QoE measurement stored in the buffer.

Example 29 is an apparatus for a User Equipment (UE) comprising one or more processors configured to: in a radio resource control (RRC) connected state, receive an RRC message including a quality of experience (QoE) pre-configuration to configure QoE buffer management in an RRC idle or inactive state, terminate or suspend the RRC connected state with a base station and enter the RRC idle or inactive state, and in the RRC idle or inactive state, discard a QoE measurement result from a buffer based on the QoE pre-configuration.

Example 30 comprises the subject matter of any variation of example 29, wherein the RRC message is an RRC release message.

Example 31 comprises the subject matter of any variation of example 29, wherein the RRC message is an RRC reconfiguration message.

Example 32 comprises the subject matter of any variation of example 29, wherein the QoE measurement is discarded upon expiration of an expiry timer, wherein the expiry timer is indicated in the QoE pre-configuration.

Example 33 comprises the subject matter of any variation of example 32, wherein the expiry timer is associated with a QoE measurement configuration identity (ID).

Example 34 comprises the subject matter of any variation of example 32, wherein the expiry timer is associated with a slice identity (ID).

Example 35 comprises the subject matter of any variation of example 32, wherein the expiry timer is associated with a service type.

Example 36 comprises the subject matter of any variation of example 29, wherein the QoE measurement result is discarded in response to a size of QoE measurements results in the buffer exceeding a size of the buffer.

Example 37 comprises the subject matter of any variation of example 36, wherein the QoE measurement result is discarded upon obtaining a new QoE measurement result.

Example 38 comprises the subject matter of any variation of example 37, wherein the one or more processors are further configured to: store the new QoE measurement result in the buffer after discarding the QoE measurement result.

Example 39 comprises the subject matter of any variation of example 29, wherein the one or more processors are further configured to: discard an entirety of QoE measurement results in the buffer in response to a size of the entirety of QoE measurement results in the buffer exceeding a size of the buffer.

Example 40 comprises the subject matter of any variation of example 29, wherein the one or more processors are further configured to: discard one or more QoE measurement results in the buffer in response to a size of entirety of QoE measurement results in the buffer, wherein the one or more QoE measurement results are selected based on UE implementation.

Example 41 comprises the subject matter of any variation of example 29, wherein the QoE measurement result is discarded based on a priority level indicated in the QoE pre-configuration.

Example 42 comprises the subject matter of any variation of example 41, wherein the priority level is associated with a QoE measurement configuration identity (ID).

Example 43 comprises the subject matter of any variation of example 41, wherein the priority level is associated with a slice identity (ID).

Example 44 comprises the subject matter of any variation of example 41, wherein the priority level is associated with a service type.

Example 45 is an apparatus for a base station, comprising one or more processors configured to send a radio resource control (RRC) message to a user equipment (UE), the RRC message including a quality of experience (QoE) pre-configuration to configure QoE buffer management in an RRC idle or inactive state, and send an RRC release message to terminate or suspend an RRC connected state with the UE, wherein the QoE pre-configuration includes an expiry timer or a priority level to configure the QoE buffer management.

Example 46 comprises the subject matter of any variation of example 45, wherein the QoE pre-configuration includes the expiry timer, and wherein the expiry timer is associated with one of a QoE configuration measurement configuration identity (ID), a slice ID, or a service type.

Example 47 comprises the subject matter of any variation of example 45, wherein the QoE pre-configuration includes the priority level, and wherein the priority level is associated with one of a QoE configuration measurement configuration identity (ID), a slice ID, or a service type.

Example 48 is a method to be performed by a User Equipment (UE) comprising: in a radio resource control (RRC) connected state, receiving an RRC message including a quality of experience (QoE) pre-configuration to configure QoE buffer management in an RRC idle or inactive state, terminating or suspending the RRC connected state with a base station and entering the RRC idle or inactive state, and in the RRC idle or inactive state, discarding a QoE measurement result from a buffer based on the QoE pre-configuration.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-48. (canceled)

49. An apparatus for a User Equipment (UE), comprising:
one or more processors configured to:
in a radio resource control (RRC) connected state, receive an RRC message including a quality of experience (QoE) pre-configuration to configure QoE measurements in an RRC idle or inactive state;
terminate or suspend the RRC connected state with a base station and enter the RRC idle or inactive state; and
in the RRC idle or inactive state, perform the QoE measurements based on the QoE pre-configuration.

50. The apparatus of claim 49, wherein the RRC message is an RRC reconfiguration message or an RRC release message.

51. The apparatus of claim 50, wherein the one or more processors are further configured to:
perform a QoE measurement upon terminating or suspending the RRC connected state with the base station as configured by the RRC release message.

52. The apparatus of claim 49, wherein the one or more processors are further configured to:
perform a QoE measurement in the RRC idle or inactive state based on the QoE pre-configuration;
store a result of the QoE measurement in a buffer; and
send a QoE report message to the base station, wherein the QoE report message includes the result of the QoE measurement stored in the buffer.

53. The apparatus of claim 52, wherein the one or more processors are further configured to:
receive a paging message before sending the QoE report message, wherein the paging message includes a paging cause indicating that the paging message is a request for a QoE report.

54. The apparatus of claim 53, wherein the one or more processors are further configured to:
determine that a size of results of QoE measurements in the buffer exceeds a second threshold value; and
enter the RRC connected state in response to the paging message and the determination;
wherein the QoE report message is sent to the base station while in the RRC connected state.

55. The apparatus of claim 54, wherein the one or more processors are further configured to:
upon entering the RRC connected state, send an RRC resume complete message to the base station indicating a size of QoE measurements stored in the buffer.

56. The apparatus of claim 53, wherein the QoE report message is part of a small data transmission (SDT) message.

57. The apparatus of claim 56, wherein the QoE report message is sent in response to a size of QoE measurements in the buffer being lower than a second threshold value.

58. The apparatus of claim 56, wherein the QoE report message is sent in response to a reference signal received power (RSRP) value or a reference signal received quality (RSRQ) value being higher than a threshold value.

59. The apparatus of claim 56, wherein the SDT message is sent via a signaling radio bearer (SRB) 4.

60. The apparatus of claim 53, wherein the paging message includes a QoE measurement configuration identity (ID) associated with the performed QoE measurement, a service type associated with the performed QoE measurement, or a slice ID associated with the performed QoE measurement.

61. The apparatus of claim 53, wherein the one or more processors are further configured to:
receive a second paging message before the paging message, the second paging message including the paging cause indicating that the paging message is a request for a QoE report; and
ignore the second paging message in response to a size of results of QoE measurements in the buffer being lower than a first threshold value.

62. An apparatus for a base station, comprising:
one or more processors configured to:
send a radio resource control (RRC) reconfiguration message including a quality of experience (QoE) pre-configuration to a UE, wherein the QoE pre-configuration configures the UE for QoE reporting in an RRC idle or inactive state;
send an RRC release message to terminate or suspend an RRC connected state with the UE; and
receive a QoE report message from the UE;
wherein the QoE report message includes a result of a QoE measurement performed by the UE while in the RRC idle or RRC inactive state, and wherein the QoE report message is based on the QoE pre-configuration.

63. The apparatus of claim 62, wherein the RRC release message includes an additional QoE pre-configuration to further configure or reconfigure QoE reporting in the RRC idle or inactive state.

64. The apparatus of claim 62, wherein the one or more processors are further configured to:
send a paging message to the UE including an indication to resume QoE measurement activities, wherein the QoE report message is received in response to the indication.

65. The apparatus of claim 64, wherein the paging message includes a QoE measurement configuration identity (ID) associated with the QoE measurement, or a service type associated with the QoE measurement.

66. The apparatus of claim 64, wherein the one or more processors are further configured to:
send a downlink control information (DCI) message to a plurality of UEs before sending the paging message, the DCI comprising an early paging indication (EPI);
wherein the QoE report message is received in response to the DCI message.

67. A method for a User Equipment (UE), comprising:
in an RRC connected state, receiving a radio resource control (RRC) message including a quality of experience (QoE) pre-configuration to configure QoE measurements in an RRC idle or inactive state;
terminating or suspending the RRC connected state with a base station and entering the RRC idle or inactive state; and
in the RRC idle or inactive state, performing the QoE measurements based on the QoE pre-configuration.

68. The method of claim 67, further comprising:
upon receiving the QoE pre-configuration, determining whether to measure or report QoE in the RRC idle or inactive state based on a character parameter of the UE;
and transmitting the determination of whether to measure or report QoE in the RRC idle or inactive state to the base station.
